(19) United States
(12) Patent Application Publication
(10) Pub. No.: US 2004/0043666 A1
(43) Pub. Date: Mar. 4, 2004

(54) Shunt receptable and plug device

(76) Inventor: Teng-Shun Hung, Taichung (TW)

Correspondence Address: Teng-Shun Hung, 58, MA YUAN WEST ST., TAICHUNG, TW

(21) Appl. No.: 10/231,310

(22) Filed: Aug. 28, 2002

(51) Int. Cl. H01R 25/00

(52) U.S. Cl. 439/651

(57) ABSTRACT

A shunt receptable and plug device has a main case, a head cover, an end cover, and a pair of disk fasteners. The end cover has a receptable set and a pair of opposite notches. The main case has a pair of plug blades, a post, an electric source socket set, a pair of telephone socket slots, two pairs of opposite insertion grooves, two opposite positioning apertures, and a top illumination indicator. The head cover has a pair of opposite circular holes, a top oblong holes, and a pair of side round holes. The end cover covers the main case. The head cover covers the main case. Each disk fastener is disposed on the head cover.

### BACKGROUND OF THE INVENTION

The present invention relates to a shunt receptable and plug device. More particularly, the present invention relates to a shunt receptable and plug device which is connected to an electric source plug and a telephone cord plug.

A conventional receptable device receives an electric source plug only. Another conventional receptable device receives a telephone cord plug only. When a personal computer is communicated with a network, two or more conventional receptable devices are required.

### SUMMARY OF THE INVENTION

An object of the present invention is to provide a shunt receptable and plug device which can be connected to an electric source plug and a telephone cord plug at the same time.

Another object of the present invention is to provide a shunt receptable and plug device which has an end cover to cover a main case while a pair of plug blades of the main case is not used.

Another object of the present invention is to provide a shunt receptable and plug device which has a head cover to cover an end cover so that the end cover will not be disengaged from the main case.

Accordingly, a shunt receptable and plug device comprises a main case, a head cover, an end cover, and a pair of disk fasteners. The end cover has a receptable set and a pair of opposite notches. The main case is in a semicircular shape. The main case has a pair of plug blades disposed on a linear side of the main case, a post disposed under the plug blades, an electric source socket set disposed on a semicircular side of the main case, a pair of telephone socket slots formed on the semicircular side of the main case, two pairs of opposite insertion grooves, two opposite positioning apertures, and a top illumination indicator. The head cover has a pair of opposite circular holes, a top oblong holes, and a pair of side round holes. Each of the disk fasteners has a positioning pin and a pair of click pillars. The post is inserted in the end cover. The end cover covers the main case. The head cover covers the main case. Each of the disk fasteners is disposed on the head cover. Each positioning pin is inserted in the corresponding positioning aperture of the main case. Each click pillar is inserted in the corresponding insertion groove of the main case.

### BRIEF DESCRIPTION OF THE DRAWINGS

FIG. 1 is a perspective exploded view of a shunt receptable and plug device of a preferred embodiment in accordance with the present invention;

FIG. 2 is another perspective exploded view of a shunt receptable and plug device of a preferred embodiment in accordance with the present invention;

FIG. 3 is a perspective assembly view of a shunt receptable and plug device of a preferred embodiment in accordance with the present invention;

FIG. 4 is a perspective exploded view of a main case and an end cover of a preferred embodiment in accordance with the present invention;

FIG. 5 is a perspective assembly view of a shunt receptable and plug device without end cover; and

FIG. 6 is a perspective schematic view illustrating a head cover covering an end cover.

### DETAILED DESCRIPTION OF THE INVENTION

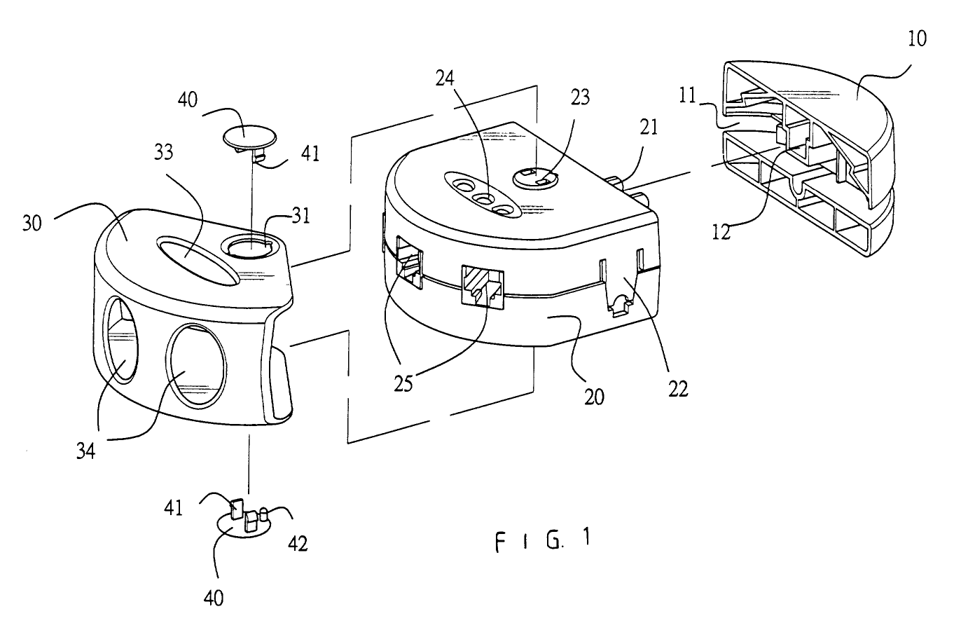

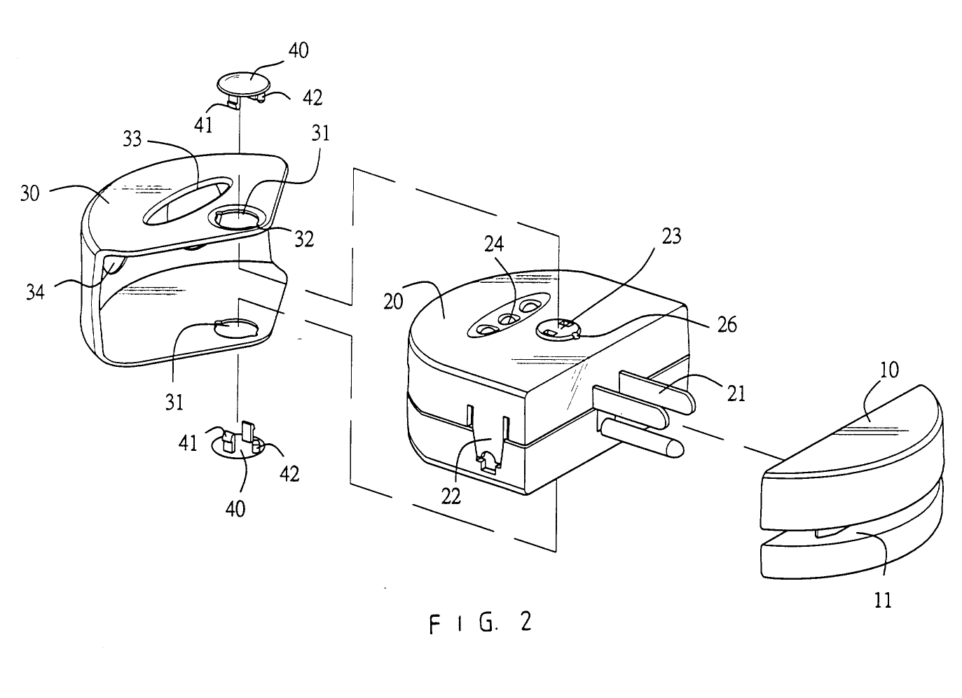

Referring to FIGS. 1 to 6, a shunt receptable and plug device comprises a main case 20, a head cover 30, an end cover 10, and a pair of disk fasteners 40.

The end cover 10 has a receptable set 12 and a pair of opposite notches 11.

The main case 20 is in a semicircular shape.

The main case 20 has a pair of plug blades 21 disposed on a linear side of the main case 20, a post 27 disposed under the plug blades 21, an electric source socket set 22 disposed on a semicircular side of the main case 20, a pair of telephone socket slots 25 formed on the semicircular side of the main case 20, two pairs of opposite insertion grooves 23, two opposite positioning apertures 26, and a top illumination indicator 24.

The head cover 30 has a pair of opposite circular holes 31, a top oblong holes 33, and a pair of side round holes 34.

Each of the disk fasteners 40 has a positioning pin 42 and a pair of click pillars 41.

The post 27 is inserted in the end cover 10.

The end cover 10 covers the main case 20.

The head cover 30 covers the main case 20.

Each of the disk fasteners 40 is disposed on the head cover 30.

Each positioning pin 42 is inserted in the corresponding positioning aperture 26 of the main case 20.

Each click pillar 41 is inserted in the corresponding insertion groove 23 of the main case 20.

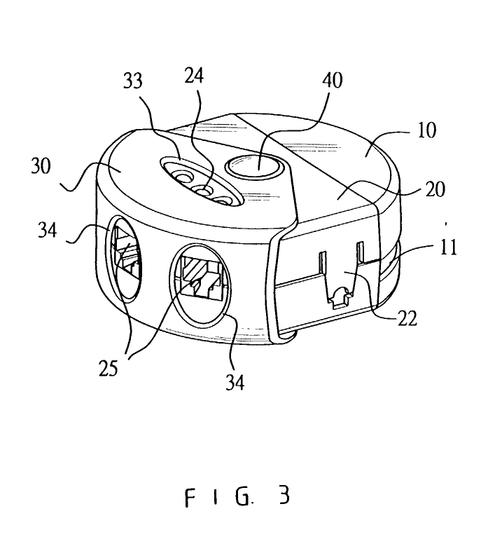

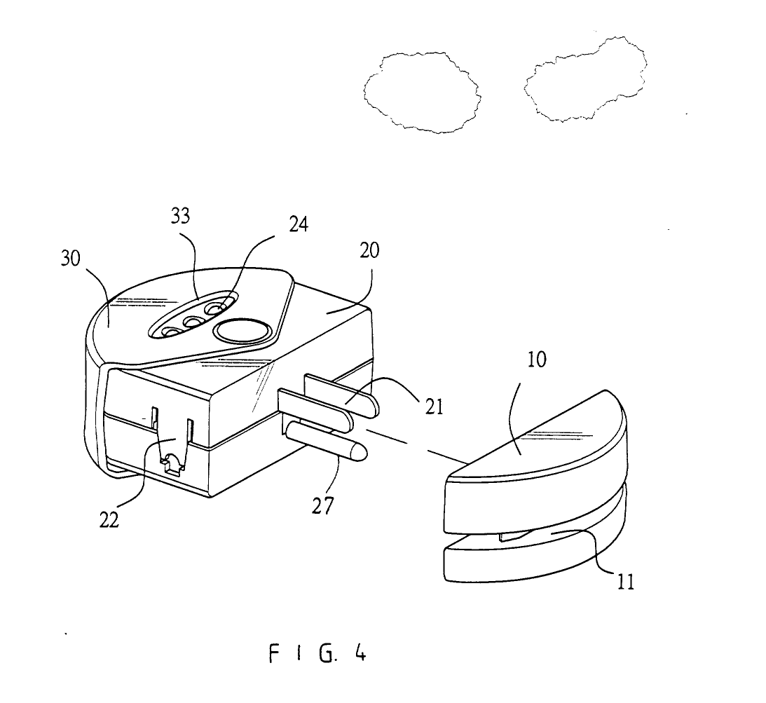

Referring to FIGS. 3 and 4, the plug blades 21 are inserted in the receptable set 12 of the end cover 10.

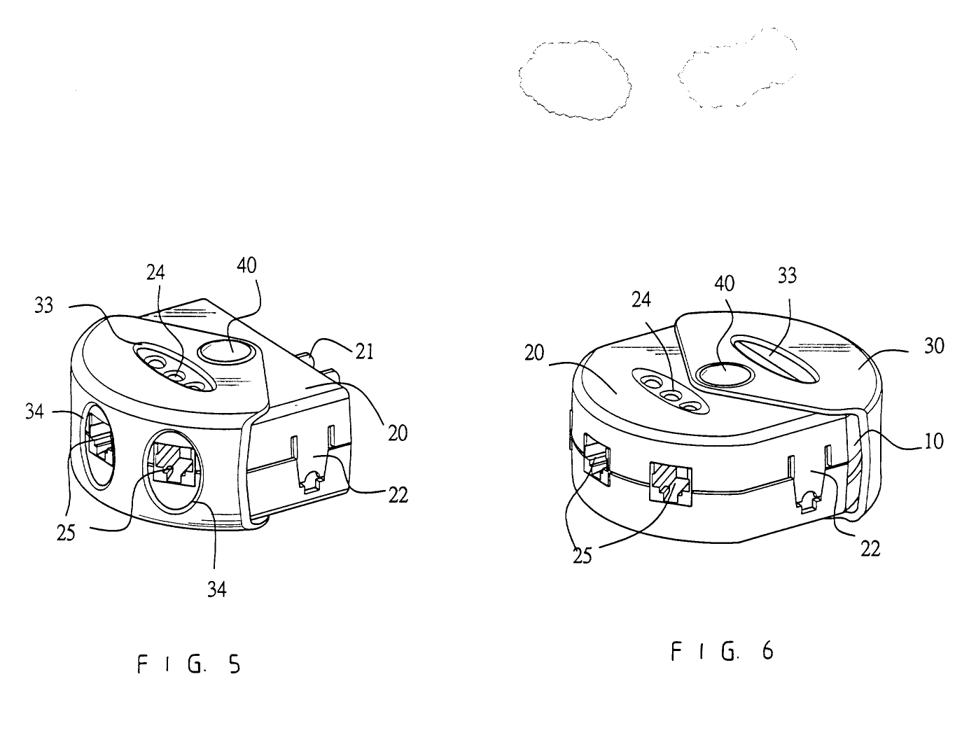

Referring to FIG. 5, the end cover 10 is removed. An electric source plug (not shown in the figure) engages with the electric source socket set 22.

Referring to FIG. 6, the head cover 30 is rotated to cover the end cover 10. One of the telephone socket slots 25 receives a telephone cord plug (not shown in the figure).

The opposite notches 11 of the end cover 10 receives a winding telephone cord (not shown in the figure).

The invention is not limited to the above embodiment but various modification thereof may be made. Further, various changes in form and detail may be made without departing from the scope of the invention.

I claim:

1. A shunt receptable and plug device comprises:
a main case, a head cover, an end cover, and a pair of disk fasteners,
the end cover having a receptable set and a pair of opposite notches,
the main case having a semicircular shape,
the main case having a pair of plug blades disposed on a linear side of the main case, a post disposed under the plug blades, an electric source socket set disposed on a semicircular side of the main case, a pair of telephone socket slots formed on the semicircular side of the main case, two pairs of opposite insertion grooves, two opposite positioning apertures, and a top illumination indicator,
the head cover having a pair of opposite circular holes, a top oblong holes, and a pair of side round holes,
each said disk fastener having a positioning pin and a pair of click pillars,
the post inserted in the end cover,
the end cover covering the main case,
the head cover covering the main case,
each said disk fastener disposed on the head cover,
each said positioning pin inserted in the corresponding positioning aperture of the main case, and
each said click pillar inserted in the corresponding insertion groove of the main case.
